(19) United States
(12) Patent Application Publication
(10) Pub. No.: US 2022/0241137 A1
(43) Pub. Date: Aug. 4, 2022

(54) PNEUMATIC COMPRESSION DEVICE WITH INTEGRATED PUMP

(71) Applicant: Therabody, Inc., Los Angeles, CA (US)

(72) Inventors: Jaime Sanchez Solana, Los Angeles, CA (US); Brian Carberry, Beverly Hills, CA (US); Brian Zeng, Dongguan City (CN); Washington Alexander Silva Garces, Los Angeles, CA (US); William Webb, San Francisco, CA (US)

(21) Appl. No.: 17/588,570

(22) Filed: Jan. 31, 2022

Related U.S. Application Data
(60) Provisional application No. 63/241,271, filed on Sep. 7, 2021.
(60) Provisional application No. 63/143,125, filed on Jan. 29, 2021.

(51) Int. Cl. A61H 9/00; A43B 7/00

(52) U.S. Cl. CPC A61H 9/005; A43B 7/00; A61H 2205/106; A61H 2201/5097; A61H 2201/1642; A61H 2201/1238; A61H 2201/165

(57) ABSTRACT

A pneumatic compression boot assembly includes a sleeve having a foot portion and a leg portion that cooperate to define a boot interior that is configured to receive a user's leg and foot, and a pump associated with the foot portion of the sleeve. The sleeve includes a plurality of inflatable compartments defined therein. The pump is configured to inflate the inflatable compartments.

### CROSS-REFERENCE TO RELATED APPLICATIONS

This application claims the benefit of U.S. Patent Application No. 63/241,271, filed Sep. 7, 2021 and U.S. Patent Application No. 63/143,125, filed Jan. 29, 2021, the entireties of which are incorporated by reference herein.

### FIELD OF THE INVENTION

The present invention relates to a pneumatic compression device, and more particularly to a pneumatic compression device with an integrated pump.

### BACKGROUND OF THE INVENTION

Pneumatic compression applied to the human body often includes a fluid pump module that is connected to an inflatable garment (i.e., full leg boots, core, or arm and shoulder sleeve) through one or multiple pipes. The air pumped from the separate module flows into the garment inflating it and compressing the body part that is inside.

The background description disclosed anywhere in this patent application includes information that may be useful in understanding the present invention. It is not an admission that any of the information provided herein is prior art or relevant to the presently claimed invention, or that any publication specifically or implicitly referenced is prior art.

### SUMMARY OF THE PREFERRED EMBODIMENTS

In accordance with an aspect of the present invention there is provided a pneumatic compression boot assembly that includes a sleeve and a pump. The sleeve includes a foot portion and a leg portion that cooperate to define a boot interior that is configured to receive a user's leg and foot. The sleeve includes a plurality of inflatable compartments defined therein and adjacent inflatable compartments may be in fluid communication with one another. The pump is associated with the foot portion of the sleeve and is configured to inflate the inflatable compartments (e.g., sequentially, individually, in sets, all at once or in any other combination). Preferably the pump is disposed in a pump housing that is positioned on a bottom of the foot portion of the sleeve. In a preferred embodiment, a bottom of the pump housing is configured to support the weight of a user. Preferably, the sleeve includes a slot defined therein that is closable and openable. The slot may be closable with a zipper or an overlapping wrap portion.

In a preferred embodiment, the boot assembly includes a control assembly and/or wireless connectivity. Preferably, the pneumatic compression boot assembly is wirelessly connectable to a software application executable on a handheld mobile device. Preferably, the inflatable compartments are arranged in an overlapping configuration. In a preferred embodiment, the pump and pump housing are a part of a pump assembly. The pump assembly is sandwiched between an insole and an outsole. Preferably, the pump assembly has the general shape of a footprint or foot.

In a preferred embodiment, the pump housing includes openings therein and conduits extend through the openings and to the compartments. Preferably, the openings are defined such that they are not directly below the foot of the wearer when the pneumatic compression boot is worn by a wearer. Preferably, the conduits extend through a pocket located in the side of the leg portion The pocket is separate from the boot interior.

The present invention is a pneumatic compression device or pneumatic compression boot that can be used for recovery after physical activities, among other uses. Pneumatic compression devices are known. For example, see U.S. Pat. Nos. 5,014,681, 5,092,317, 6,406,445, 6,558,338, 6,846,295, 8,313,450, and 8,622,943, each of which are incorporated herein by reference in its entirety.

In a preferred embodiment, the pneumatic compression boot includes a pump (compressor and/or motor) together with a battery integrated within the boot. The pump can be located anywhere within the main body portion of the boot. In a preferred embodiment, the pump and/or battery are included or located at the bottom of the foot portion of the pneumatic compression boot. It will be appreciated that in use a user will typically utilize two or right and left pneumatic compression boots. However, only one is shown in the drawings.

In a preferred embodiment, inside the main body portion of the boot, the pneumatic compression boot includes a sleeve that includes foot portion and a leg portion that cooperate to define a boot interior that is configured to receive a user's leg and foot. The sleeve includes a plurality of cells, chambers or compartments defined therein. In a preferred embodiment, the compartments are in fluid communication and are inflatable sequentially to provide compression to a user's foot and leg. The bottom of the foot portion preferably includes a chamber to ensure compression of the foot in the upward position which helps avoid blood reflux during use. In a preferred embodiment, the compression starts at the user's foot (further from the heart) and moves sequentially upwardly toward the upper leg of the user (closer to the heart). This negative gradient helps move blood toward the user's heart. Return of the blood to the heart can help with recovery, e.g., after exercise or strenuous activity. A foot and leg sleeve is shown in the drawings and described herein. However, it will be appreciated that the pneumatic compression assembly can be sized, designed and utilized on any body part. The sleeve can include overlapping compartments or cells, as discussed and taught in U.S. Pat. No. 4,338,923 and U.S. Patent Pub. No. 2013/0079692, the entireties of which are incorporated by reference herein.

In a preferred embodiment, the pump is disposed in a pump housing that is positioned on the bottom of the foot portion. Preferably, the bottom of the pump housing is configured to support the weight of a user. It will be appreciated that placement of the pump at the bottom of the boot minimizes the length of the tubes and simplifies the tube network compared to the prior art. Also, because having the pump at the bottom minimizes the noise that reaches the user's ears. It will be appreciated that including the pump, battery and other associated components at the bottom of the foot portion helps balance the pneumatic compression boot when worn, both when lying or sitting down in the boots.

In a preferred embodiment, the foot portion is designed so that the pump is hidden within the pump housing and the material or outer fabric layer that surrounds or covers the pump housing so that the pump (and battery, etc.) are not evident from the outside of the boot. However, in another embodiment (shown in the figures) the pump housing may not be covered by any fabric. Preferably, the heel portion of the boot or foot portion is where many of the electromechanical components are housed. For example, these components can be housed with the pump housing, which can be made of plastic, metal or the like. The outer layer, which can be a fabric material, surrounds and secures the pump housing. Furthermore, in a preferred embodiment, and as shown in the figures, the layout of the components in the pump unit and/or pump housing are configured to match or mimic the shape of the foot insole. Therefore, the pump unit and/or housing and/or battery and other electromechanical components, etc. (any or all of these components together are referred to herein as the pump assembly) are sandwiched between an insole (against or adjacent to which the user's foot is placed) and an “outsole”, which can be the fabric material on the bottom of the foot portion, treads, or the like, which is designed to contact the ground and support the boot. This may be advantageous if the user stands or walks in the boots. The pump assembly essentially is the midsole between the insole and the outsole.

In a preferred embodiment, the boot or sleeve includes a slot defined therein that is closable and openable so that a user can insert their foot and leg into the boot interior. The slot can be closable with a zipper. In another embodiment, the boot can include an overlapping wrap portion that includes the zipper hidden underneath or that utilizes Velcro or other closure device (snaps, buttons, hooks, clasps, straps, etc.) to close the slot. The slot and associated closure device can be located anywhere on the main body portion, let portion and/or foot portion.

In a preferred embodiment, the pneumatic compression boot includes a control assembly located adjacent a top of the leg portion. The control assembly can include buttons and switches for controlling the device, as well as a display screen, etc. Preferably, the controls are located at the top of the boot and include an integrated LED display for battery, pressure and time displays. Including the controls near the top of the boot make it easy for a wearer to reach the controls. It will be appreciated that wiring can be routed through the main body portion between the control assembly and the pump/battery at the bottom of the foot portion. In another embodiment, the battery for powering the pump and/or the pump itself, the control assembly and any other electrical components can be located anywhere within the pneumatic compression boot.

The control assembly can also include memory, a controller, wireless connectivity and other features. In a preferred embodiment, left and right pneumatic compression boots are wirelessly connected via BLE Bluetooth or the like. Furthermore, one or both of the pneumatic compression boots are wirelessly connectable to a software application executable on a handheld mobile device. For example, the boot can include a wireless transceiver, receiver and/or transmitter.

In a preferred embodiment, the bottom of the boot, foot portion or pump housing is made of a material that provides support and resistance to wear so the boot can be used on multiple types of surfaces without being easily damaged. For example, the boot can include a sole and/or tread on the bottom thereof.

In a preferred embodiment, the pneumatic compression boot includes a plurality of hoses or conduits that deliver the air from the pump assembly to the various chambers or compartments. It will be appreciated that because the pump assembly is positioned at the bottom of the pneumatic compression boot, the conduits extend upwardly from the pump housing and pump(s) and to the compartments. However, because the pump housing and at least a portion of the overall pump assembly is positioned below the wearer's foot, it is preferable that the conduits are routed around or to the outside of the wearer's foot.

In a preferred embodiment, the pump assembly, including the pump housing is attached to the bottom of the fabric boot portion. The pump housing includes a plurality of walls, including a top wall, front wall, side walls, back wall and bottom wall. The front wall, side walls, back wall and bottom wall form the lower housing. A connection panel is used to attach the pump housing to the fabric boot portion. In a preferred embodiment, conduits extend upwardly through openings in the pump housing. Openings extend through the top wall and the connection panel. A layer of fabric in the boot portion is sandwiched between the connection panel and the top wall. Preferably, the openings are positioned toward the outer side of the housing (or toward the inner side of the housing) so that the wearer does not step on the conduits and so that the conduits are routed to the side of the wearer's foot.

In a preferred embodiment, the pump assembly includes two pumps (one or more than two can be included), a battery, a valve system and a pump conduit that routes air from the pump(s) to the valve system. The valve system includes a plurality of valves (four in the embodiment shown in the drawings) that route air through a plurality of nozzles, into the conduits and to the chambers.

In a preferred embodiment, the pneumatic compression boot includes four chambers along the length of the boot and four conduits extend upwardly into the foot portion and/or the leg portion, as necessary, one conduit to each chamber. Preferably, a pocket that is separate from the boot interior that receives the wearer's leg and foot is included along the length of the boot. The conduits extend through the pocket to reach the associated chamber.

### BRIEF DESCRIPTION OF THE DRAWINGS

The invention may be more readily understood by referring to the accompanying drawings in which:

FIG. 1 is a perspective view of a pneumatic compression boot assembly in accordance with a preferred embodiment of the present invention;

FIG. 2 is a side elevation of the pneumatic compression boot assembly with a portion in cross-section;

FIG. 3 is a perspective view of the pneumatic compression boot assembly with the pump housing exploded from the foot portion;

FIG. 4 is a perspective view of the pump assembly;

FIG. 5 is a cross-section of the pump assembly taken along line 5--5 of FIG. 4;

FIG. 6 is a top exploded perspective view of the pump assembly;

FIG. 7 is a bottom exploded perspective view of the pump assembly;

FIG. 8 is perspective view of the bottom of the main body portion showing the top wall of the pump housing exploded therefrom;

FIG. 9 is a side elevational view of a portion of the pneumatic compression boot assembly showing the pump assembly in cross-section; and

FIG. 10 is a side elevational view of the pneumatic compression boot assembly with a portion of the flap cut away to show the conduits.

Like numerals refer to like parts throughout the several views of the drawings.

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are references to the same embodiment; and, such references mean at least one of the embodiments. If a component is not shown in a drawing then this provides support for a negative limitation in the claims stating that that component is “not” present. However, the above statement is not limiting and in another embodiment, the missing component can be included in a claimed embodiment.

Reference in this specification to “one embodiment,” “an embodiment,” “a preferred embodiment” or any other phrase mentioning the word “embodiment” means that a particular feature, structure, or characteristic described in connection with the embodiment is included in at least one embodiment of the-disclosure and also means that any particular feature, structure, or characteristic described in connection with one embodiment can be included in any embodiment or can be omitted or excluded from any embodiment. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others and may be omitted from any embodiment. Furthermore, any particular feature, structure, or characteristic described herein may be optional. Similarly, various requirements are described which may be requirements for some embodiments but not other embodiments. Where appropriate any of the features discussed herein in relation to one aspect or embodiment of the invention may be applied to another aspect or embodiment of the invention. Similarly, where appropriate any of the features discussed herein in relation to one aspect or embodiment of the invention may be optional with respect to and/or omitted from that aspect or embodiment of the invention or any other aspect or embodiment of the invention discussed or disclosed herein.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

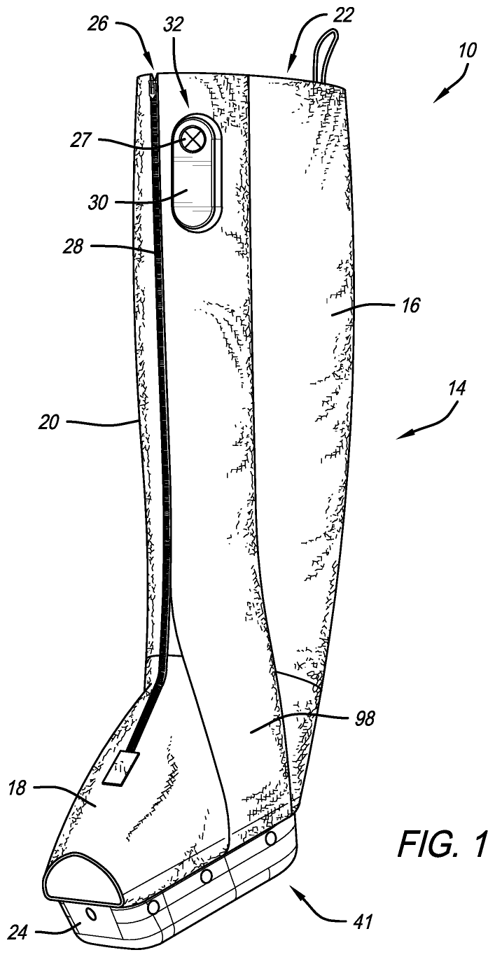

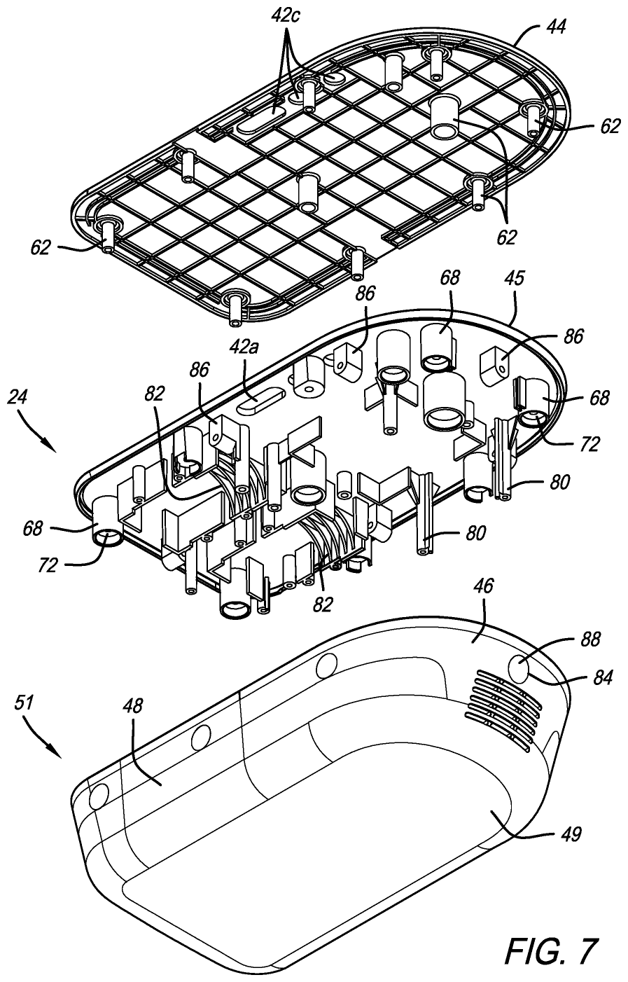

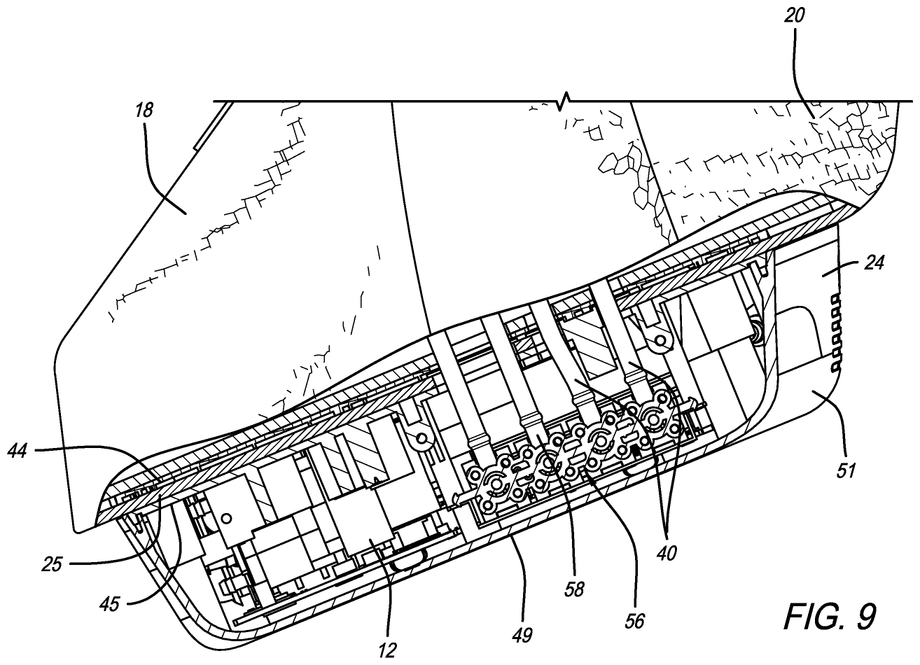

FIGS. 1-10 show a preferred embodiment of a pneumatic compression boot assembly 10. In a preferred embodiment, the pneumatic compression boot assembly 10 that includes a pump 12 (compressor and/or motor) together with a battery integrated within the boot. The pump can be located anywhere within the main body portion 14 and/or sleeve 16 of the boot. In a preferred embodiment, the pump and/or battery are included or located at the bottom of the foot portion 18 of the pneumatic compression boot assembly 10. It will be appreciated that in use a user will typically utilize two or right and left pneumatic compression boot assembles. However, only one is shown in the drawings.

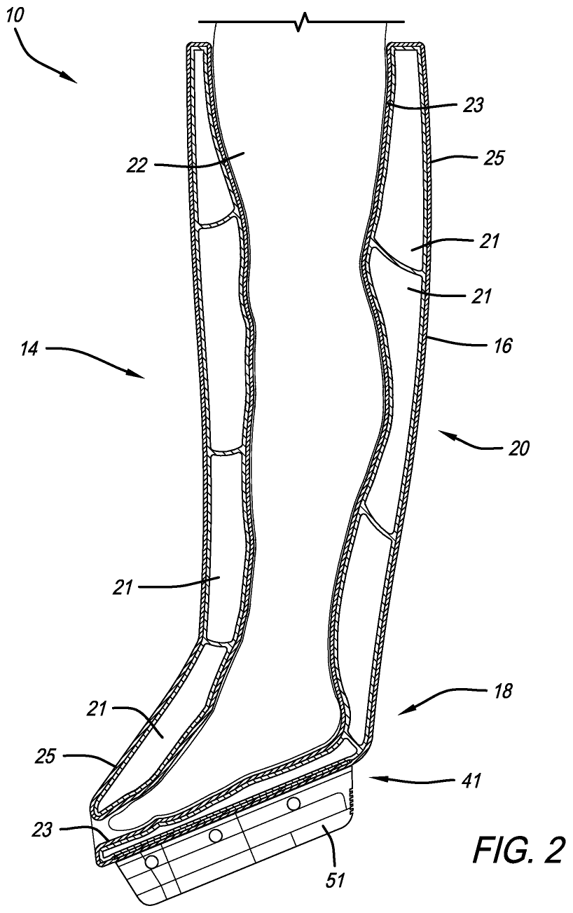

In a preferred embodiment, as shown in FIG. 2, inside the main body portion 14 of the boot, the pneumatic compression boot assembly 10 includes a sleeve 16 that includes foot portion 18 and a leg portion 20 that cooperate to define a boot interior 22 that is configured to receive a user's leg and foot. The sleeve 16 includes a plurality of cells, chambers or compartments 21 defined therein. In a preferred embodiment, the compartments 21 are inflatable sequentially (or in any other inflation pattern) to provide compression to a user's foot and leg and are also deflatable sequentially and/or simultaneously or in any other deflation pattern, as is further discussed above and herein. In a preferred embodiment, the sleeve 16 includes an inner layer 23 and an outer layer 25 that surround the plurality of compartments 21.

In a preferred embodiment, the boot or sleeve includes a slot 26 defined therein that is closable and openable so that a user can insert their foot and leg into the boot interior. The slot 26 can be closable with a zipper 28 or other closure mechanism, such as Velcro, snaps, buttons, latches or the like.

In a preferred embodiment, the pneumatic compression boot assembly 10 includes a control assembly 32 located adjacent a top of the leg portion 20. The control assembly 32 includes a housing 29 that houses the electronics therein and can include buttons 27 and switches for controlling the device (e.g., inflation and deflation cycles, etc.), as well as a display screen 30, etc. Preferably, the control assembly 32 is located at the top of the main body portion 14 and/or sleeve 16. The control assembly may also include an integrated LED display for battery, pressure and time displays. Including the controls near the top of the boot makes it easy for a wearer to reach the controls. It will be appreciated that wiring can be routed through the main body portion 14 and/or sleeve 16 between the control assembly 32 and the pump/battery and associated components at the bottom of the foot portion 18. In another embodiment, the battery for powering the pump and/or the pump itself, the control assembly and any other electrical components can be located anywhere within or one the pneumatic compression boot assembly.

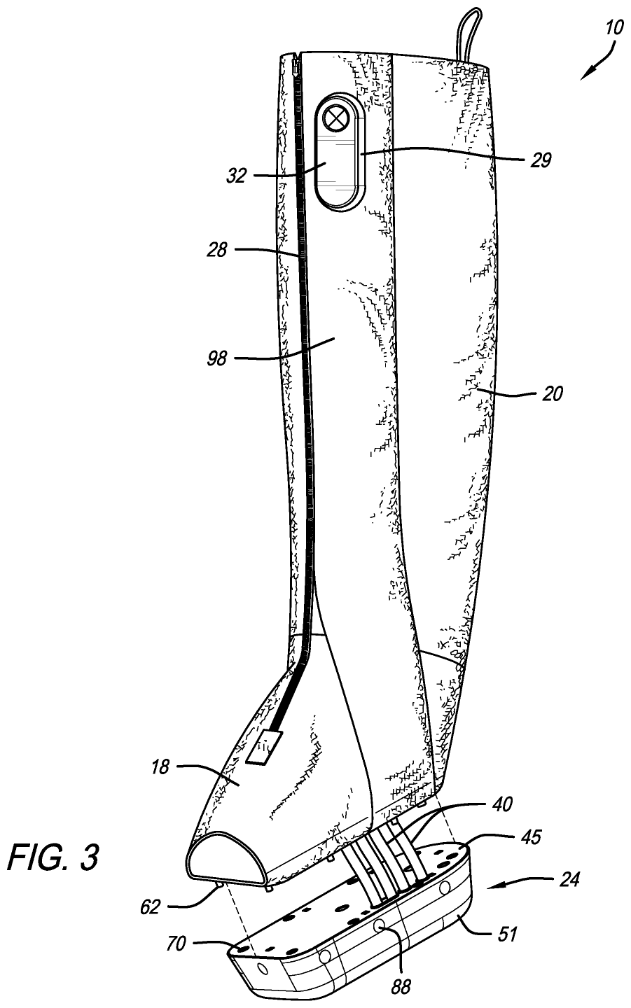

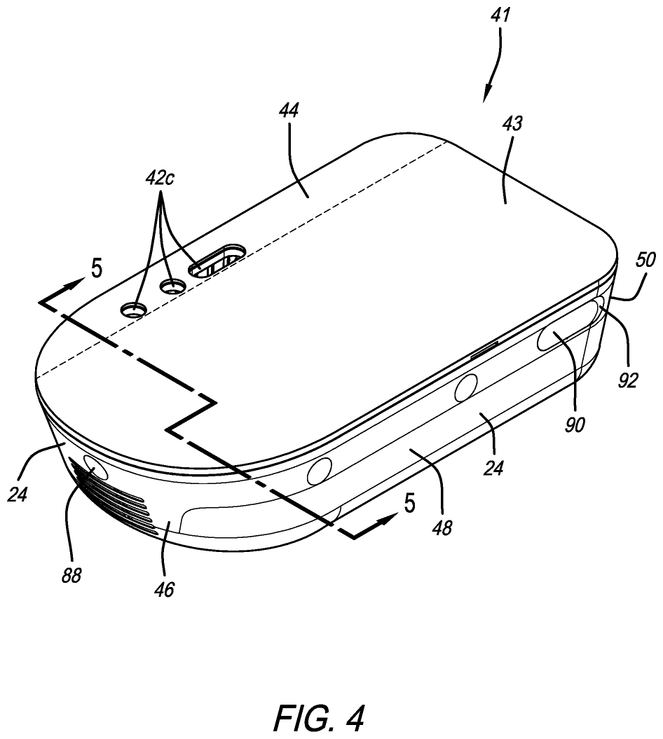

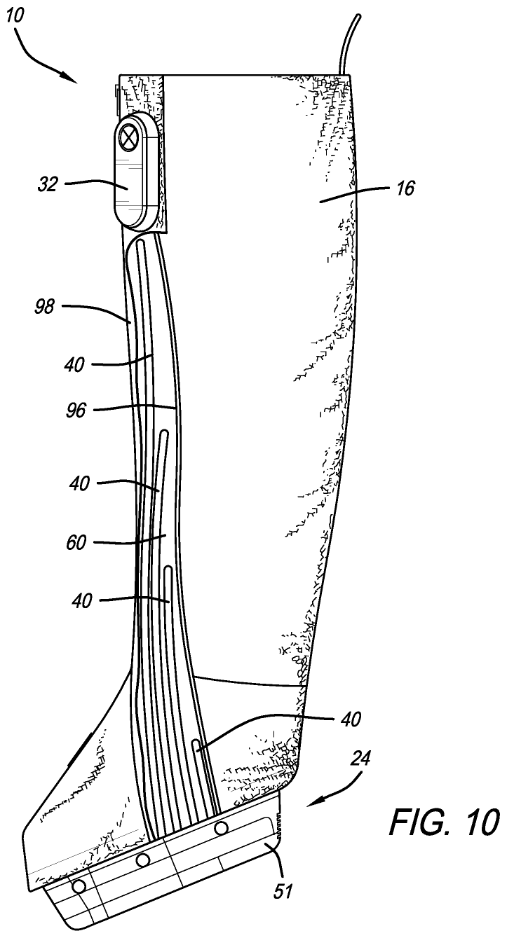

In a preferred embodiment, the pump 12 is disposed in a pump housing 24 that is positioned on the bottom of the foot portion 18. FIGS. 3-9 show the pump housing 24 and pump assembly 41. As shown in FIG. 3, in a preferred embodiment, the pneumatic compression boot assembly 10 includes a plurality of hoses or conduits 40 that deliver the air from the pump(s) 12 to the various chambers or compartments 21. FIG. 3 shows the pump housing 24 exploded from the foot portion 18 so that the conduits 40 can be seen extending into the pump housing 24. It will be appreciated that because the pump assembly 41 is positioned at the bottom of the pneumatic compression boot assembly 10, the conduits 40 extend upwardly from the pump housing 24 and pump(s) 12 and to the compartments 21 (see FIG. 10). However, because the pump housing 24 and at least a portion of the overall pump assembly 41 is positioned below the wearer's foot, it is preferable that the conduits 40 are routed around or to the outside (lateral side) of the wearer's foot. See the dashed line in FIG. 4 showing an exemplary separation between the third conduit openings 42c in the connection panel 44 from the area 43 located below the wearer's foot.

FIGS. 4-9 show the pump assembly 41, including the pump housing 24 and the interior thereof and how it attaches to the bottom of the foot portion 18. The pump housing 24 includes a plurality of walls, including an upper or top wall 45, front wall 46, side walls 48, back wall 50 and bottom wall 49. The front wall 46, side walls 48, back wall 50 and bottom wall 49 form the lower housing 51. A connection panel 44 is also included and is a part of the pump assembly 41, as described further below. In a preferred embodiment, conduits 40 extend upwardly through openings in the pump housing 24, the outer layer 25 of the sleeve 16 and the connection panel 44. The openings are referred to herein as conduit openings. The first and third conduit openings 42a and 42c are defined in and extend through the top wall 45 and the connection panel 44, respectively. The second conduit openings 42b is defined and extends through the outer layer 25, which is sandwiched between the top wall 45 and connection panel 44, as described herein. As shown in FIG. 4, preferably, the conduit openings (the third conduit openings 42c are shown in FIG. 4) are positioned toward the outer or lateral side of the housing (or toward the inner or medial side of the housing) so that the wearer does not step on the conduits 40 and so that the conduits are routed to the side of the wearer's foot.

In a preferred embodiment, the pump assembly 41 includes two pumps 12 (one or more than two can be included), a battery 54, a valve system 56, and a pump conduit 52 that routes air from the pump (2) to the valve system 56. The valve system 56 includes a plurality of valves (four in the embodiment shown in the drawings) that route air through a plurality of nozzles 58, into the conduits 40 and to the compartments 21.

In a preferred embodiment, the pneumatic compression boot assembly 10 includes four compartments 21 along the length of the boot and four conduits 40 extend upwardly into the foot portion 18 and/or the leg portion 20, as necessary, one conduit to each chamber, as shown in FIG. 10. Preferably, a pocket 60 that is separate from the boot interior 22 that receives the wearer's leg and foot is included along the length of the boot. The conduits 40 extend through the pocket 60 to reach the associated chamber.

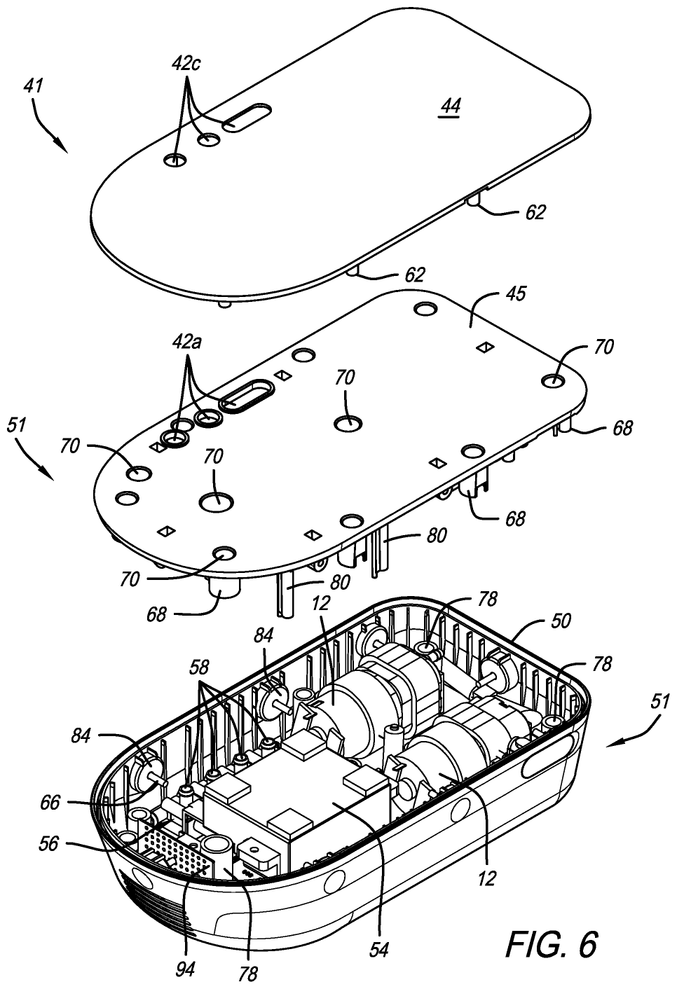

FIGS. 6-9 show the pump assembly 41 and how the pump housing 24 is preferably attached to the bottom of the foot portion 18 using the connection panel 44. The connection panel 44 is positioned inside the sleeve 16 and a layer of fabric is sandwiched between the connection panel 44 and the top wall 45. The top wall 45 is attached to the lower housing 51, which houses the internal/hardware components of the pump assembly, such as the pumps 12, the valve system 56, nozzles 58, battery 54, etc.

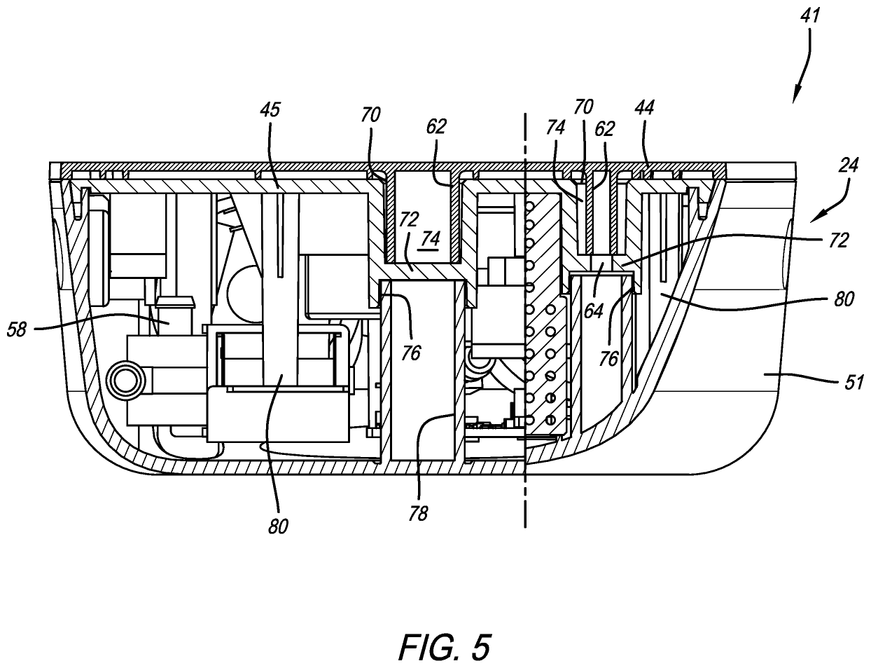

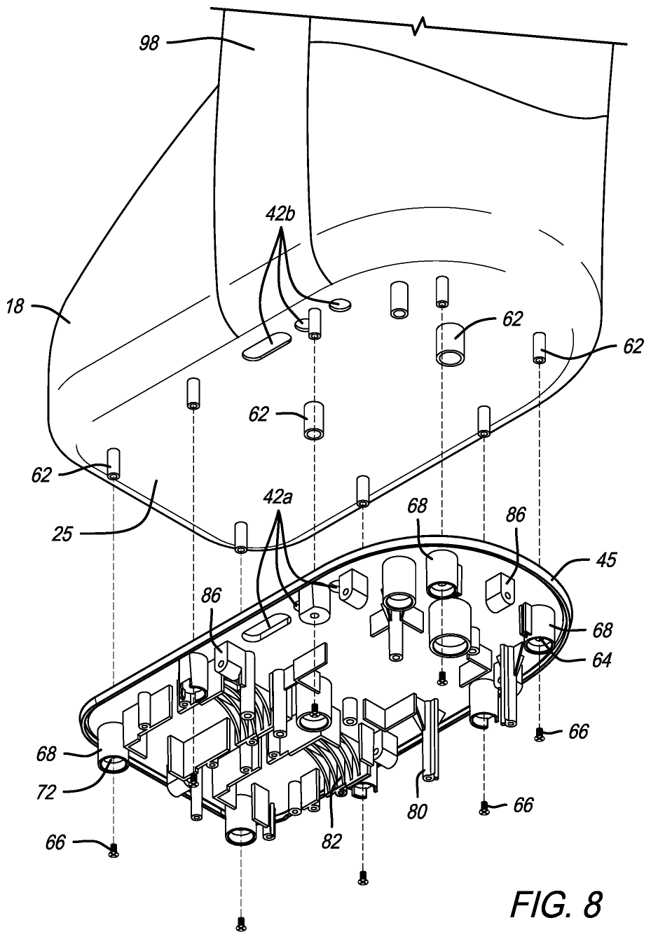

As shown in FIG. 5, in a preferred embodiment, the connection panel 44 includes a plurality of upper alignment posts 62 extending downwardly from the bottom surface thereof. Some of the upper alignment posts 62 include a fastener opening 64 through which a threaded fastener (e.g., a screw 66, as is shown in FIG. 8) extends to connect the upper alignment post 62 of the connection panel 44 to one of the alignment receivers 68 that extend downwardly from the bottom surface of the top wall 45. The top wall 45 includes an alignment opening 70 defined therethrough. The upper alignment posts 62 extend through the outer layer 25 of the sleeve 16 and into the alignment openings 70. Preferably, each alignment opening 70 is at least partially defined by one of the alignment receivers 68. In a preferred embodiment, one or more of the alignment receivers 68 each include a separator member 72 that separates the alignment receiver 68 (or the central opening thereof) into an upper receiver portion 74 and a lower receiver portion 76. The upper alignment post 62 extends downwardly into the upper receiver portion 74. Preferably, the lower housing 51 includes lower alignment posts 78 that extend upwardly into the lower receiver portion 76. The lower alignment posts 78 can extend from the upper surface of the bottom wall 49.

As shown in FIGS. 5-8, the pump assembly 41 includes a number of other components for securing the parts of the housing together, preventing movement or rattling therein and spacing the various components apart. A plurality of spacing posts 80 extend downwardly from the top wall 45. Bracket members 82 are also included on the lower surface of the top wall 45 to maintain the pumps 12 in place. Recessed screw holes 84 are included through the side walls of the lower housing 51. Screws or other threaded fasteners extend through the screw holes 84 and into openings in attachment protrusions 86 in the lower housing 51. Rubber (or other material) screw hold covers 88 may be received in the recessed portion of the recessed screw holes 84. A rubber charging port cover 90 may be removably inserted into the charging port 92 (for charging the battery 54) of the pump housing.

As shown in FIG. 6, the pump housing also includes a PCB or motherboard 94 for controlling the pumps 12 and other components and that is in electrical and/or data communication with the control assembly 32 via a wire(s) or cable 96 (see FIG. 10). The cable 96 may extend through a separate opening in the pump assembly 41 (through the connection panel 44, outer layer 25 and top wall 45) or through one of the conduit openings (e.g., the elongated conduit opening shown in the drawings). FIG. 10 also shows the conduits 40 extending upwardly from the pump assembly 41, through pocket 60 and to the various compartments. The pocket 60 may be covered by a flap 98 (most of which is cut away in FIG. 10). The flap 98 may include Velcro for holding it in a closed position. The flap may also be sewed or otherwise stitched of welded in the closed position.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize. Further, any specific numbers noted herein are only examples: alternative implementations may employ differing values, measurements or ranges.

Although the operations of any method(s) disclosed or described herein either explicitly or implicitly are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

The teachings of the disclosure provided herein can be applied to other systems, not necessarily the system described above. The elements and acts of the various embodiments described above can be combined to provide further embodiments. Any measurements or dimensions described or used herein are merely exemplary and not a limitation on the present invention. Other measurements or dimensions are within the scope of the invention.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

These and other changes can be made to the disclosure in light of the above Detailed Description of the Preferred Embodiments. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. § 112, ¶6, other aspects may likewise be embodied as a means-plus-function claim, or in other forms, such as being embodied in a computer-readable medium. (Any claims intended to be treated under 35 U.S.C. § 112, ¶6 will include the words “means for”). Accordingly, the applicant reserves the right to add additional claims after filing the application to pursue such additional claim forms for other aspects of the disclosure.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A pneumatic compression boot assembly, comprising:
a sleeve that includes a foot portion and a leg portion that cooperate to define a boot interior that is configured to receive a user's leg and foot, wherein the sleeve includes a plurality of inflatable compartments defined therein, and
a pump associated with the foot portion of the sleeve, wherein the pump is configured to inflate the plurality of inflatable compartments.

2. The pneumatic compression boot assembly of claim 1, further comprising a pump assembly that includes a pump housing that is positioned on a bottom of the foot portion of the sleeve, wherein the pump is disposed in the pump housing.

3. The pneumatic compression boot assembly of claim 2, wherein the pump assembly includes a connection panel, wherein the pump housing includes a lower housing and a top wall that cooperate to define a housing interior, and wherein an outer layer of the sleeve is disposed between a bottom surface of the connection panel and a top surface of the top wall.

4. The pneumatic compression boot assembly of claim 3, wherein the top wall includes at least one first conduit opening, the outer layer of the sleeve includes at least one second conduit opening and the connection panel includes at least one third conduit opening, wherein a first conduit extends through the first, second and third conduit openings and pneumatically communicates the pump with at least one of the plurality of inflatable compartments.

5. The pneumatic compression boot assembly of claim 3, wherein the connection panel includes an upper alignment post extending downwardly from the bottom surface, wherein the top wall includes an alignment opening defined therethrough, and wherein the upper alignment post extends through the outer layer of the sleeve and into the alignment opening.

6. The pneumatic compression boot assembly of claim 5, wherein the alignment opening is at least partially defined by an alignment receiver, wherein the alignment receiver includes a separator member, which separates the alignment receiver into an upper receiver portion and a lower receiver portion, wherein the upper alignment post extends downwardly into the upper receiver portion, wherein the lower housing includes a lower alignment post that extends upwardly into the lower receiver portion.

7. The pneumatic compression boot assembly of claim 5, wherein the alignment opening is at least partially defined by an alignment receiver, wherein a threaded fastener extends through the alignment receiver and is threadedly received in the upper alignment post.

8. The pneumatic compression boot assembly of claim 2, wherein a first conduit extends through an outer layer of the foot portion, into the pump housing and pneumatically communicates the pump with at least one of the plurality of inflatable chambers.

9. The pneumatic compression boot assembly of claim 4, wherein the first, second and third conduit openings are defined such that they are not directly below the foot of the user when the pneumatic compression boot is worn.

10. The pneumatic compression boot assembly of claim 9, wherein the first conduit extends through a pocket located in a side of the leg portion, wherein the pocket is separate from the boot interior.

11. The pneumatic compression boot assembly of claim 1, further comprising a control assembly associated with the sleeve.

12. The pneumatic compression boot assembly of claim 1, further comprising wireless transceiver.

13. The pneumatic compression boot assembly of claim 12, wherein the pneumatic compression boot is configured to be in wireless communication with a handheld mobile device.

14. The pneumatic compression boot assembly of claim 12, wherein the pneumatic compression boot is configured to be in wireless communication with a second pneumatic compression boot.

15. A pneumatic compression boot assembly, comprising:
a sleeve that includes a foot portion and a leg portion that cooperate to define a boot interior that is configured to receive a user's leg and foot, wherein the sleeve includes a plurality of inflatable compartments defined therein, and
a pump assembly that includes a pump housing that is positioned on a bottom of the foot portion of the sleeve, wherein a pump that is configured to inflate the plurality of inflatable compartments is disposed in the pump housing, wherein the pump assembly includes a connection panel, wherein the pump housing includes a lower housing and a top wall that cooperate to define a housing interior, wherein an outer layer of the sleeve is disposed between a bottom surface of the connection panel and a top surface of the top wall, wherein the top wall includes at least one first conduit opening, the outer layer of the sleeve includes at least one second conduit opening and the connection panel includes at least one third conduit opening, wherein a first conduit extends through the first, second and third conduit openings and pneumatically communicates the pump with at least one of the plurality of inflatable compartments, wherein the first, second and third conduit openings are defined such that they are not directly below the foot of the user when the pneumatic compression boot is worn, wherein the connection panel includes an upper alignment post extending downwardly from the bottom surface, wherein the top wall includes an alignment opening defined therethrough, wherein the upper alignment post extends through the outer layer of the sleeve and into the alignment opening, wherein the alignment opening is at least partially defined by an alignment receiver, wherein the alignment receiver includes a separator member that separates the alignment receiver into an upper receiver portion and a lower receiver portion, wherein the upper alignment post extends downwardly into the upper receiver portion, wherein the lower housing includes a lower alignment post that extends upwardly into the lower receiver portion, and wherein a threaded fastener extends through the alignment receiver and is threadedly received in the upper alignment post.
